(19) United States
(12) Patent Application Publication
(10) Pub. No.: US 2008/0200156 A1
(43) Pub. Date: Aug. 21, 2008

(54) METHODS AND APPARATUS TO PROVIDE MEDICAL INFORMATION USING A COMMUNICATION SYSTEM

(76) Inventors: Mary Anne Hicks, Garland, TX (US); Gary R. Hicks, Garland, TX (US); William Bingham, Sacramento, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/676,166

(22) Filed: Feb. 16, 2007

(51) Int. Cl. H04M 3/42

(52) U.S. Cl. 455/415

(57) ABSTRACT

Methods and apparatus to provide medical information using a communication system are disclosed. An example method includes receiving a caller ID number and providing access to personal medical information based on the caller ID number.

### FIELD OF THE DISCLOSURE

This disclosure relates generally to communication systems and, more particularly, to methods and apparatus to provide medical information using a communication system.

### BACKGROUND

Recently, medical and emergency services providers have recommended that mobile phone users store an entry for an emergency contact in their mobile phone's address booked labeled as ICE (in case of emergency). Typically, the emergency contact is a relative who is familiar with the mobile phone user and, more importantly, is familiar with the user's medical information. If the mobile phone user is in an emergency situation, a medical provider that locates the user's mobile phone can call the ICE number to alert the contact and/or to get medical information about the mobile phone user.

Of course, using the ICE address book entry is only as good as the emergency contact. If the emergency contact is not available at the time of the emergency or is ill-informed about the user's medical information, the procedure might not be helpful.

### BRIEF DESCRIPTION OF THE DRAWINGS

FIG. 1 is a block diagram of an example system for providing medical information over a communication system.

FIG. 2 is a block diagram of an example implementation of the medical information provider of FIG. 1.

FIG. 3 is a flowchart representative of example machine readable instructions that may be executed to handle requests for medical information from the mobile phone 102 of FIG. 1.

FIG. 4 is a flowchart representative of a second implementation of example machine readable instructions that may be executed to handle requests for medical information from the mobile phone 102 of FIG. 1.

FIG. 5 is a block diagram of an example computer that may execute the machine readable instructions of FIGS. 3 and/or 4 to implement the example system of FIG. 1 and/or the example medical information provider of FIG. 2.

### DETAILED DESCRIPTION

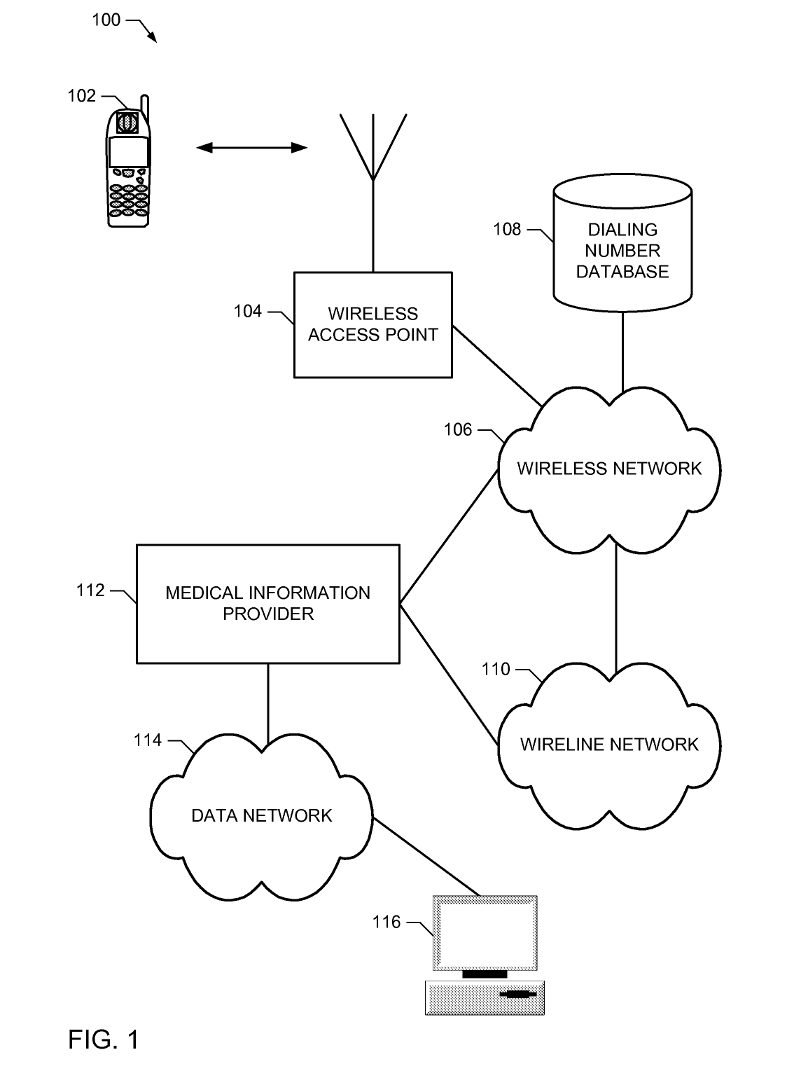

FIG. 1 is a block diagram of an example system 100 for providing medical information over a communication system. In the illustrated example, the communication system is a mobile telephone network. A mobile phone 102 is used to contact a medical information provider 112. The example medical information provider 112 determines the identity of the mobile phone 102 and/or a user of the mobile phone 102. The medical information provider 112 then sends medical information associated with the identity of the mobile phone 102 and/or the user of the mobile phone 102 to the mobile phone 102. The information may include information about one or more prescriptions, one or more medical conditions, one or more allergies, one or more preferred doctors or hospitals, one or more medical treatments that the user has undergone, emergency contact information, etc. associated with the mobile phone 102 and/or the user of the mobile phone 102.

The example system 100 of FIG. 1 includes a wireless access point 104, a wireless network 106, a dialing number database 108, a wireline network 110, the medical information provider 112, a data network 114, and a computer 116.

The mobile phone 102 of the illustrated example allows a user to send and receive mobile telephone calls via the wireless access point 104. The example mobile phone 102 includes a keypad for receiving user input such as, for example, a telephone number, a pin number, an access number, etc. The example mobile phone 102 additionally includes a microphone for receiving audible user input (e.g., spoken words) and a speaker for outputting audible output. Persons of ordinary skill in the art will recognize that the mobile phone 102 may additionally include any other desired feature(s) such as, for example, a display screen, indicators (e.g., light emitting diodes (LEDs), directional pad input controls, a joystick input control, one or more switches, a touchscreen user input, etc. While a mobile phone 102 is illustrated, the mobile phone 102 may alternatively be replaced with a voice over internet protocol (VoIP) telephone, a public switched telephone network (PSTN) telephone, a wireless network telephone (e.g., a telephone that operates according to the 802.11 protocol), a personal digital assistant (PDA), a laptop computer, a desktop computer, a smart phone, a gaming device, etc. In addition to enabling a user to send and/or receive mobile telephone calls, the mobile phone 102 may additionally or alternatively enable a user to send and/or receive text messages, to send and/or receive webpage information (e.g., to send requests for a webpage and to receive a webpage), to send and/or receive communication pages, to store and/or play audio data (e.g., music files), to receive and/or execute applications, to send and/or receive walkie-talkie communications, to take, send, and/or receive pictures and/or video, etc.

The wireless access point 104 of the illustrated example communicatively couples the mobile phone 102 with the wireless network 106. The example wireless access point 104 is communicatively coupled to the wireless network 106. The wireless access point 104 of the illustrated example is coupled to the mobile phone 102 via a past, present, and or future mobile phone communication protocol such as, for example, the code division multiple access (CDMA) protocol; the global system for mobile (GSM) communication protocol; the time division multiple access (TDMA) protocol; the personal communication service (PCS) protocol; any first generation (1G), second generation (2G), third generation (3G), and/or fourth generation (4G) communication protocol; the integrated digital enhanced network (iDEN) protocol, the general packet radio service (GPRS) protocol, the 1× evolution-data optimized (EV-DO) service; the universal mobile telecommunications system (UTMS) protocol; the advanced mobile phone system (AMPS) protocol, etc. Alternatively, the wireless access point 104 may be a central office (CO) for a PSTN, a wireless data access point (e.g., an access point for a wireless network that operates according to an 802.11 communication protocol), a voice over internet protocol (VoIP) access point, etc.

The wireless network 106 of the illustrated example enables communication between two or more devices connected to the wireless network 106 (e.g., the mobile phone 102, which is connected to the wireless network 106 via the wireless access point 104). The wireless network 106 may operate according to any past, present, and/or future protocol including for instance, one or more of the mobile communication protocols listed above in conjunction with the wireless network access point 104. Alternatively, the wireless network 106 may be replaced with a PSTN, a wireless data network, a VoIP network, etc.

The wireless network 106 includes components for receiving and routing mobile communications. When the wireless network 106 receives a telephone call, the wireless network 106 may query the dialing number database 108 to determine how to route the telephone call. For example, if the call is directed to an 800 number, a three digital dialing code (e.g., 411), a three digit access code or star (*) code (e.g., *423), or any other number, the wireless network 106 may query the dialing number database 108 to determine how to route the call. The wireless network 106 of the illustrated example is communicatively coupled to the medical information provider 112 (e.g., directly and/or via the wireline network 110).

The dialing number database 108 of the illustrated example provides information describing how telephone calls should be routed to a destination. The dialing number database 108 may be a line information database (LIDB), an 800 number database, a three-digit dialing code database, an access code (*) database, and/or any other type of database. In response to a query with a dialing number, the dialing number database 108 provides information for routing a call to the destination associated with the dialing number (e.g., a ten digit routing number).

The wireline network 110 of the illustrated example may optionally connect the wireless network 106 to the medical information provider 112. The wireline network 110 may be any type of network for communicatively coupling devices such as, for example, a local area network (LAN), a wide area network (WAN), another wireless network, the internet, the PSTN, etc. While the wireline network 110 and the data network 114 are illustrated as discrete components, the wireline network 110, the data network 114, and/or the wireless network 106 may alternatively be integrated as a single network.

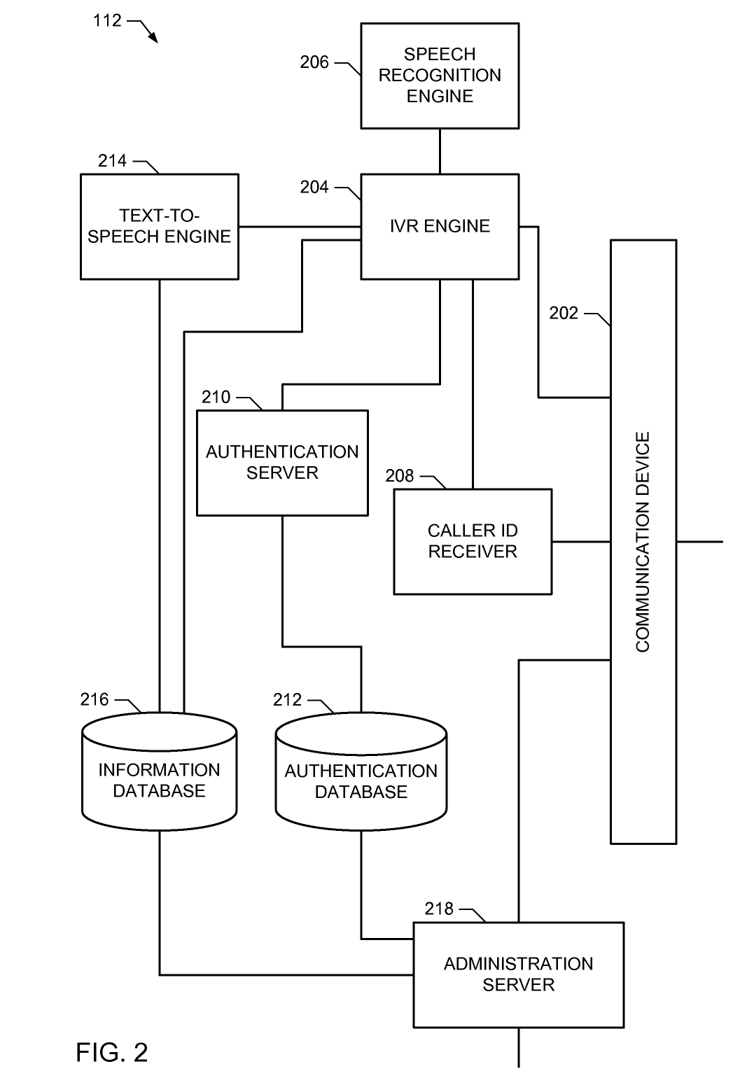

The medical information provider 112 of the illustrated example receives requests for personal medical information (e.g., medical information associated with a specific person) and sends the medical information to the source of the request. In the illustrated example, the medical information provider 112 receives a request for medical information from the mobile phone 102 (e.g., via the wireless access point 104, the wireless network 106, and, in some implementations, through the wireline network 110). In response to the request, the example medical information provider 112 verifies the identity of the mobile phone 102 and/or the user of the mobile phone 102 and sends medical information associated with the mobile phone 102 and/or the user of the mobile phone 102 back to the mobile phone 102. The example medical information provider 112 is also capable of allowing administration (e.g., inputting medical information, deleting stored medical information, modifying access settings, etc.). The medical information provider 112 of the illustrated example is described in further detail in conjunction with FIG. 2.

The data network 114 of the illustrated example communicatively couples the medical information provider 112 with the computer 116. The data network 114 may be any type of data network or communication connection such as, for example, a LAN, a WAN, a cable communication connection, a DSL communication connection, the internet, etc. As previously described, the data network 114 may be integrated with the wireline network 110. Persons of ordinary skill will recognize that further devices (other than the computer 116 and the medical information provider 112) may additionally or alternatively be connected to the data network such as, for example, additional computers.

The computer 116 of the illustrated example allows a user to connect to the medical information provider 112 to create, delete, and/or edit medical records. The computer 116 may be any device that allows a user to work with the medical records such as, for example, a laptop computer, a desktop computer, a PDA, a mobile phone, a smart phone, etc.

FIG. 2 is a block diagram of an example implementation of the medical information provider 112 of FIG. 1. The example medical information provider 112 of FIG. 2 includes a communication device 202, a interactive voice response (IVR) engine 204, a speech recognition engine 206, a caller ID receiver 208, an authentication server 210, an authentication database 212, a text-to-speech engine 214, an information database 216, and an administration server 218.

The communication device 202 of the illustrated example communicatively couples the medical information provider 112 of FIG. 2 with the wireless network 106 and/or the wireline network 110. The example communication device 202 is capable of sending and receiving audio information (e.g., voice information and/or touch tone information from the mobile phone 102 of FIG. 1). In addition, the example communication device 202 may be capable of sending and receiving data information (e.g., hypertext markup language (HTML), caller ID data, etc). The communication device 202 transmits data to and/or receives data from one or more of the IVR engine 204, the caller ID receiver 208, and/or the administration server 218.

The IVR engine 204 of the illustrated example provides an interactive voice menu to a caller (e.g., a user of the mobile phone 102) to allow the caller to interact with the medical information provider 112 without the need for a screen. For example, the IVR engine 204 may greet a calling user with a recorded message when the user calls the medical information provider (e.g., using a specified 800 number, three digit access code, etc.). The IVR engine 204 may then read a menu of options to the user and ask the user to press a button or say a name corresponding to a desired menu. While an IVR engine is illustrated in FIG. 2, the IVR engine 204 may alternatively be replaced and/or assisted by a device for providing information using another medium or functionality such as, for example, a web page server, a text message server, etc.

When the example IVR engine 204 receives spoken inputs (e.g., a user of the mobile phone 102 speaking requests), the IVR engine 204 works with the speech recognition engine 206 of the illustrated example to identify the user's request. The example speech recognition engine 206 receives spoken words and converts the words to computer readable data. The example speech recognition engine 206 may additionally be capable of using speech patterns to identify a user's voice. For example, upon receiving an incoming request for information, the IVR engine 204 may instruct the user to speak a certain phrase (e.g., a password) and the speech recognition engine 206 may compare the spoken words to stored information to identify the user.

To identify the source of incoming calls requesting information, the IVR engine 204 works with the caller ID receiver 208 of the illustrated example to identify the caller ID number associated with the source of the incoming call (e.g., the mobile phone 102). The caller ID receiver 208 receives caller ID information from the communication device 202 and/or the IVR engine 204 and determines a caller ID number associated with the incoming call. For example, the caller ID receiver 208 may receive caller ID information from an automatic number identification (ANI) system, a calling number identification (CNID) system, a calling line identification (CLI) system, a calling line identification presentation (CLIP) system, a calling line identification (CLID) system, etc. The caller ID receiver 208 of the illustrated example then transmits the caller ID number to the IVR engine 204. The caller ID receiver 204 may alternatively identify other identifying information associated with the mobile phone 102 and/or a user of the mobile phone 102. For example, the caller ID receiver 204 may identify a serial number associated with the mobile phone 102, an account number/name associated with the mobile phone 102, etc.

The example IVR engine 204 works with the authentication server 210 of the illustrated example to identify and/or authenticate users requesting information from the medical information provider 112. The IVR engine 204 transmits identifying information for the source of the information request to the authentication server 210. The example authentication server 210 compares the information received from the IVR engine 204 to information stored in the authentication database 212 to determine if the medical information provider has stored information associated with the user. In addition, the example authentication server 210 may determine if any received information can be used to authenticate the user. For example, the IVR engine 204 may send the authentication server 210 one or more of a caller ID number (e.g., identified by the caller ID receiver 208), a user identifier/password/personal identification number (PIN) (e.g., received from the mobile phone via the input keypad or received from the speech recognition engine 206), an identified serial number for the mobile phone 102, etc.

The authentication server 210 of the illustrated example determines if the received identification information matches to one or more corresponding records in the authentication database 212. For example, the authentication server 210 may determine if a received caller ID number and a PIN match a set of records, which would indicate that the correct PIN has been entered for the caller ID source. Additionally or alternatively, the authentication engine 210 may determine if a first subset of the received identifying information indicates that the source of the request is authorized to access information associated with a second subset of the received identifying information. For example, a received caller ID number may be used to identify the medical information records that are to be retrieved from the information database 216 and a received user identifier and PIN may identify the user as a medical provider that is authorized to access medical information about the owner of the mobile phone 102 (e.g., medical information associated with the caller ID number).

The authentication database 212 of the illustrated example stores authentication information for verifying the authority of requests for medical information. The authentication database 212 may be any type of data storage such as, for example, a database, a hard drive, a file, etc. The authentication database 212 may be accessed for modification by the administration server 218 to allow the creation, removal, and/or modification of authentication records.

The text-to-speech engine 214 of the illustrated example receives requests for information from the IVR engine 204, retrieves the requested information from the information database 216, and converts the requested information to spoken words. The text-to-speech engine 214 may be excluded from the medical information provider 112 when information is transmitted to users via text or when the information is stored in the information database 216 as spoken words.

The information database 216 of the illustrated example stores medical information. The medical information may be any type of information that a user of the medical information provider 112 may desire to store such as, for example, information about one or more prescriptions assigned to the user, information about one or more allergies associated with the user, information about one or more medical conditions associated with the user, information about one or more previous medical procedures associated with the user, information about medical personnel associated with the user (e.g., preferred doctors and/or hospitals), information about one or more emergency contacts associated with the user, etc. The information database 216 of the illustrated example may be any type of data storage such as, for example, a database, a hard drive, a file, etc.

The administration server 218 of the illustrated example provides webpage information that allows users to manage the medical and/or authentication information used by the medical information provider 112. The administration server 218 may receive an administration request from the communication device 202 (e.g., a request from the mobile phone 102) and/or the data network 114 of FIG. 1 (e.g., from the computer 116). While the example administration server 218 is described as a webpage server, the administration server 218 may alternatively interact with a user using any other type of interface such as, for example, using an IVR engine (similar to IVR engine 204).

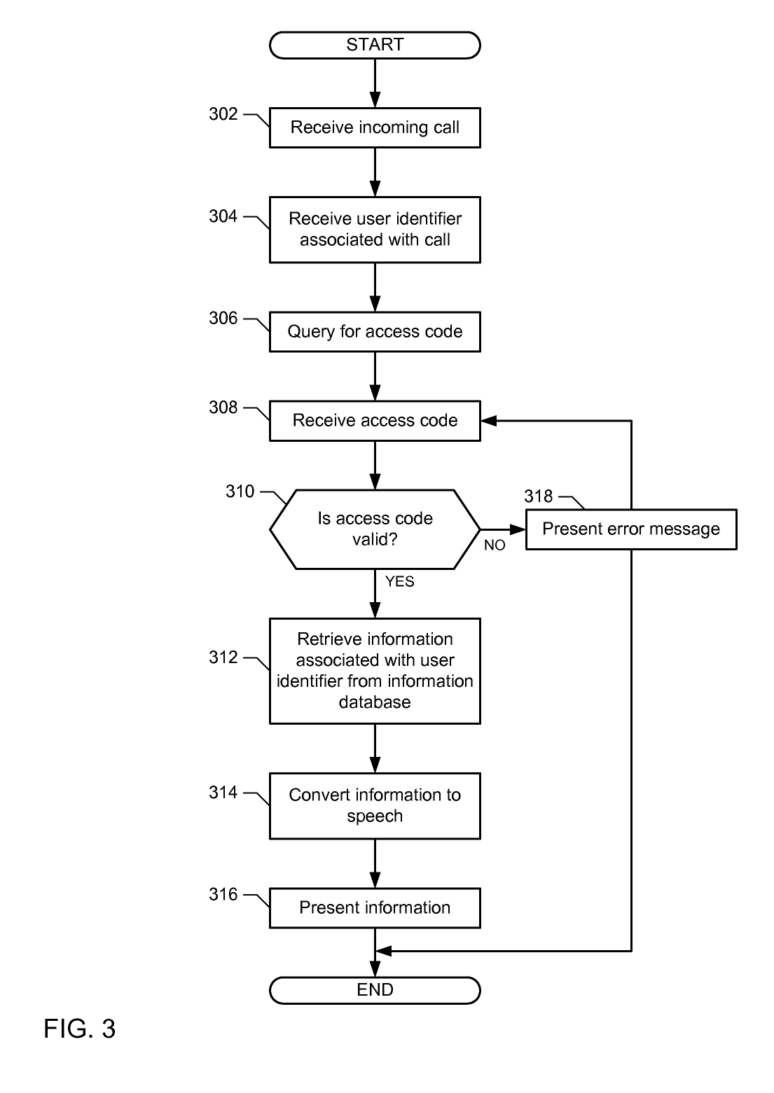

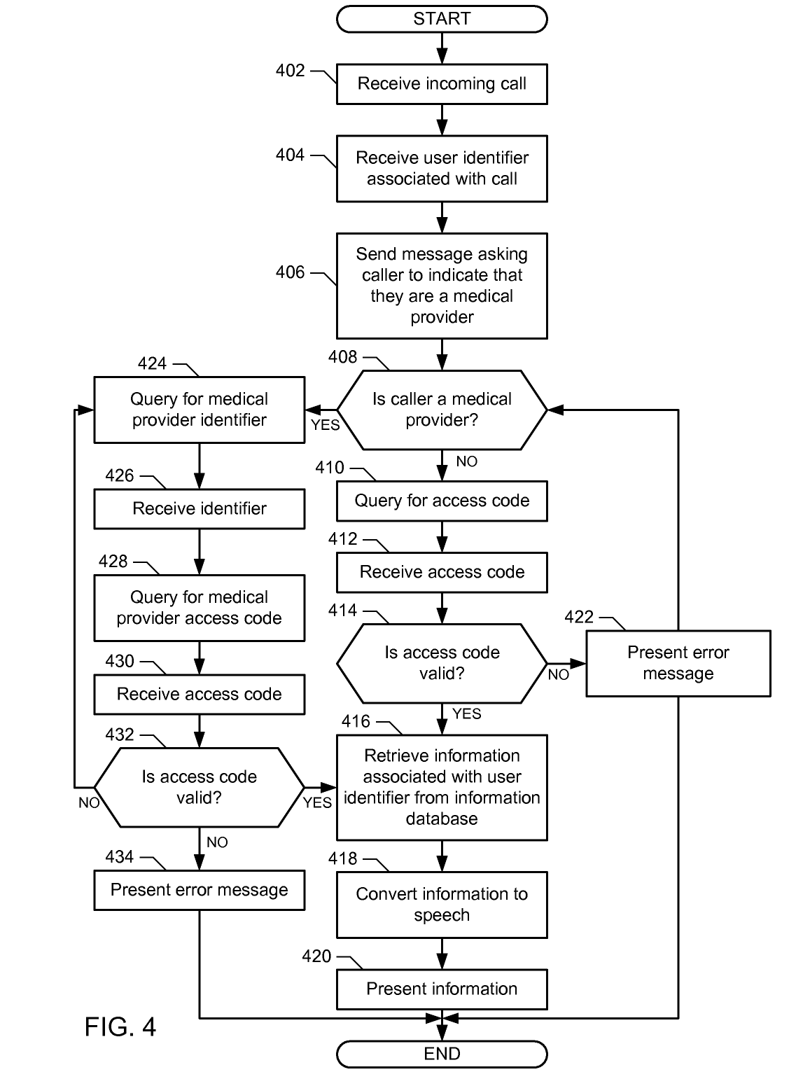

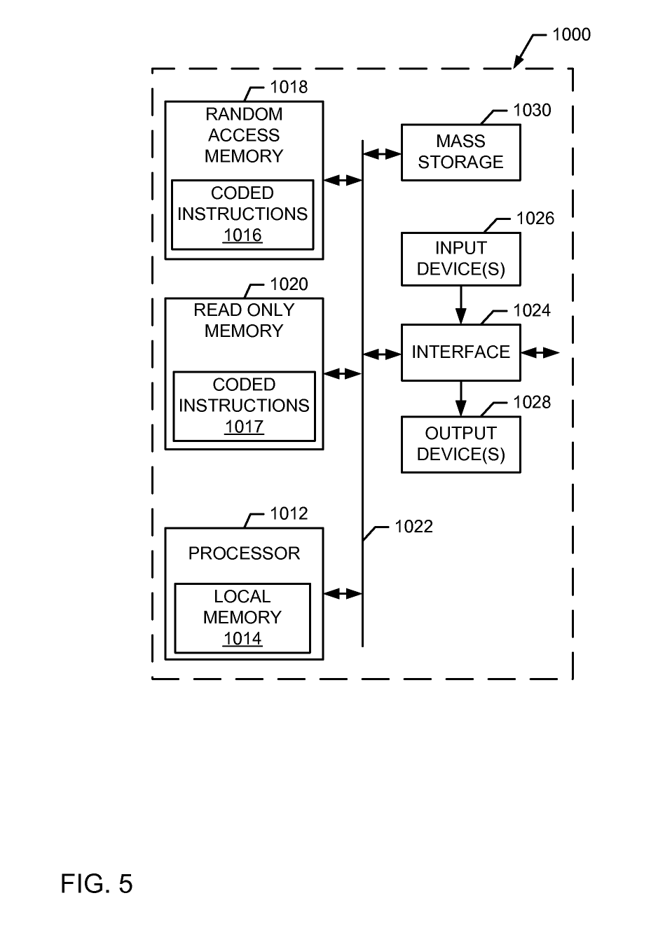

FIGS. 3-4 are flowcharts representative of example machine readable instructions that may be executed to implement the mobile phone 102, the wireless access point 104, the wireless network 106, the dialing number database 108, the wireline network 110, the medical information provider 112, the data network 114, and/or the computer 116 of FIG. 1 and/or the communication device 202, the IVR engine 204, the speech recognition engine 206, the caller ID receiver 208, the authentication server 210, the authentication database 212, the text-to-speech engine 214, the information database 216, and/or the administration server 218 of FIG. 2. The example machine readable instructions of FIGS. 3-4 may be executed by a processor, a controller, and/or any other suitable processing device. For example, the example machine readable instructions of FIGS. 3-4 may be embodied in coded instructions stored on a tangible medium such as a flash memory, or random access memory (RAM) associated with a processor (e.g., the processor 1012 shown in the example processor platform 1000 and discussed below in conjunction with FIG. 5). Alternatively, some or all of the example flowcharts of FIGS. 3-6 may be implemented using an application specific integrated circuit (ASIC), a programmable logic device (PLD), a field programmable logic device (FPLD), discrete logic, hardware, firmware, etc. In addition, some or all of the example flowcharts of FIGS. 3-4 may be implemented manually or as combinations of any of the foregoing techniques. For example, any or all of the mobile phone 102, the wireless access point 104, the wireless network 106, the dialing number database 108, the wireline network 110, the medical information provider 112, the data network 114, and/or the computer 116 of FIG. 1 and/or the communication device 202, the IVR engine 204, the speech recognition engine 206, the caller ID receiver 208, the authentication server 210, the authentication database 212, the text-to-speech engine 214, the information database 216, and/or the administration server 218 of FIG. 2 may be implemented by a combination of firmware, software, and/or hardware. Further, although the example system 100 and/or the medical information provider 112 are implemented by executing the example machine readable instructions represented by the flowcharts of FIGS. 3-4, persons of ordinary skill in the art will readily appreciate that many other methods of implementing instructions represented by FIGS. 3-4 may be employed. For example, the order of execution of the blocks may be changed, and/or some of the blocks described may be changed, eliminated, sub-divided, and/or combined. Additionally, persons of ordinary skill in the art will appreciate that the example machine readable instructions of FIGS. 3-4 may be carried out sequentially and/or carried out in parallel by, for example, separate processing threads, processors, devices, circuits, etc.

FIG. 3 is a flowchart representative of example machine readable instructions that may be executed to handle requests for medical information received from a mobile phone 102 of FIG. 1. The example machine readable instructions of FIG. 3 begin when the communication device 202 of the medical information provider 112 receives an incoming call (e.g., a call from the mobile phone 102) (block 302). The IVR engine 204 and/or the caller ID receiver 208 receives a user identifier (e.g., a caller ID number, a serial number, a user name, an account name/number, etc.) associated with the call (block 304). The IVR engine 204 queries the caller for an access code (e.g., a password, a PIN, etc.) (block 306). For example, an access code may be printed on the phone, printed on a label that is attached to the phone, etc. The access code may be used to prevent a device that is spoofing the caller ID number from gaining access to the personal medical information. The IVR engine 204 then receives the access code (block 308). In an alternate implementation, block 306 and block 308 may be eliminated if no access code is desired (e.g., for implementations where anyone calling from a given phone is provided access to the medical information associated with that phone by using the caller ID number as a key to access the database).

After receiving the access code, the authentication server 210 queries the authentication database 212 with the received user identifier and/or access code to determine if the received user authorization credentials match a valid record (block 310). If the user authorization credentials do not match a valid record, the IVR engine 204 sends an error message (e.g., a spoken message, a text message, etc.) to the mobile phone 102. Control then proceeds to block 308 to give the user another opportunity to input the access code or the machine readable instructions of FIG. 3 complete (e.g., the call is disconnected).

If the user authorization credentials match a valid record, the IVR engine 204 and/or the text-to-speech engine 214 retrieve the requested information associated with the valid record from the information database 216 (block 312). The example text-to-speech engine 214 then converts the retrieved information to spoken words (block 314). Persons of ordinary skill in the art will recognize that the conversion will not be performed if the retrieved information is already in the form of spoken words and/or if a text response is more appropriate. The IVR engine 204 then sends the retrieved information (e.g., to spoken words) to the mobile phone 102 for presentation (block 316). Then, the machine readable instructions of FIG. 3 end and the call is completed. Alternatively, the IVR engine 204 may send (e.g., via spoken words) a menu of choices to the mobile phone 102 to allow a user to end the call or to request further information.

FIG. 4 is a flowchart representative of a second implementation of example machine readable instructions that may be executed to handle requests for medical information received from the mobile phone 102 of FIG. 1. The example machine readable instructions of FIG. 4 begin when the IVR engine 204 of the medical information provider 112 receives an incoming call (e.g., a call from the mobile phone 102) (block 402). The communication device 202 and/or the caller ID receiver 208 receives a user identifier (e.g., a caller ID number, a serial number, a user name, an account name/number, etc.) associated with the call (block 404). The IVR engine 204 then queries the caller to indicate whether or not they are a medical provider (e.g., “Press * if you are a medical provider) (block 406). If the caller indicates that they are a medical provider (e.g., the “*” dual tone, multi-frequency (DTMF) tone is received), control proceeds to block 424, which is described below.

If the caller does not indicate that they are a medical provider (e.g., a different tone is received or no tone is received), the IVR engine 204 queries the caller for an access code (e.g., a password, a PIN, etc.) (block 410). The IVR engine 204 then receives the access code (block 412). In an alternate implementation block 406 and block 408 may be eliminated if no access code is desired.

After receiving the access code, the authentication server 210 queries the authentication database 212 with the received authorization credentials (e.g., the user identifier and access code) to determine if the user authorization credentials match a valid record (block 414). If the user authorization credentials do not match a valid record, the IVR engine 204 sends an error message (e.g., a spoken message, a text message, etc.) to the mobile phone 102 (block 422). Control then proceeds to block 408 to give the user another opportunity to input an appropriate access code or, if a number of access attempts (FIG. 3) have failed, the machine readable instructions of FIG. 4 complete (e.g., the call is disconnected).

If the authorization credentials match a valid record, the IVR engine 204 and/or the text-to-speech engine 214 retrieve the requested information associated with the valid record from the information database 216 (block 416). The example text-to-speech engine 214 then converts the retrieved information to spoken words (block 418). Persons of ordinary skill in the art will recognize that the conversion will not be performed if the retrieved information is already in the form of spoken words or if a text response is to be used. The IVR engine 204 then sends the retrieved information (e.g., converted to spoken words) to the mobile phone 102 for presentation (block 420). Then, the machine readable instructions of FIG. 4 end and the call is disconnected. Alternatively, the IVR engine 204 may send (e.g., via spoken words) a menu of choices to the mobile phone 102 to allow a user to end the call or to request further information.

Returning to block 408, if the caller indicates that they are a medical provider, the IVR engine 204 queries the user for a medical provider identifier (block 424). For example, a medical provider may be assigned a user identifier (e.g., a number, username, etc.) that provides authorization to access any user's medical records. The IVR engine 204 then receives an input medical provider identifier from the mobile phone 102 (block 426). The IVR engine 204 then queries the user for a medical provider access code (block 428). For example, the medical provider may be assigned a password associated with the medical provider identifier. The IVR engine 204 then receives the medical provider access code from the mobile phone 102 (block 430).

After receiving the medical provider identifier and the medical provider access code, the authentication server 210 determines if the received medical provider identifier and medical provider access code match a valid record in the authentication database 212 (block 432). If the medical provider identifier and the medical provider access code match a valid record in the authentication database 212, control proceeds to block 416 to retrieve information associated with the user identifier received in block 404. If the medical provider identifier and/or the medical provider access code do not match a valid record, the IVR engine 204 sends an error message to the mobile phone 102 (block 434). Control then returns to block 424 to request the medical provider information again or the machine readable instructions of FIG. 4 end and the call is completed (e.g., after a predefined number of access attempts fail).

FIG. 5 is a block diagram of an example computer platform 1000 capable of executing the machine readable instructions illustrated in FIGS. 3, and/or 4 to implement the system 100, the medical information provider 112, and/or the other apparatus and/or methods disclosed herein.

The computer platform 1000 of the instant example includes a processor 1012 such as a general purpose programmable processor. The processor 1012 includes a local memory 1014, and executes coded instructions 1016 present in random access memory 1018, coded instruction 1017 present in the read only memory 1020, and/or instructions present in another memory device. The processor 1012 may execute, among other things, the machine readable instructions represented in FIGS. 3, and/or 4. The processor 1012 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1012 is in communication with a main memory including a volatile memory 1018 and a non-volatile memory 1020 via a bus 1022. The volatile memory 1018 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1020 may be implemented by flash memory and/or any other desired type of memory device. Access to the main memory 1018, 1020 is typically controlled by a memory controller (not shown) in a conventional manner.

The computer 1000 also includes a conventional interface circuit 1024. The interface circuit 1024 may be implemented by any type of well known interface standard, such as an Ethernet interface, a universal serial bus (USB), and/or a third generation input/output (3GIO) interface.

One or more input devices 1026 are connected to the interface circuit 1024. The input device(s) 1026 permit a user to enter data and commands into the processor 1012. The input device(s) can be implemented by, for example, a keyboard, a mouse, a touchscreen, a track-pad, a trackball, isopoint and/or a voice recognition system.

One or more output devices 1028 are also connected to the interface circuit 1024. The output devices 1028 can be implemented, for example, by display devices (e.g., a liquid crystal display, a cathode ray tube display (CRT), a printer and/or speakers). The interface circuit 1024, thus, typically includes a graphics driver card.

The interface circuit 1024 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1000 also includes one or more mass storage devices 1030 for storing software and data. Examples of such mass storage devices 1030 include floppy disk drives, hard drive disks, compact disk drives and digital versatile disk (DVD) drives.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

Although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method of providing access to personal medical information, the method comprising:
receiving a caller ID number; and
providing access to personal medical information based on the caller ID number when the caller ID number matches a stored caller ID number associated with the personal medical information.

2. A method as defined in claim 1, wherein access to the personal medical information associated with the caller ID number is provided when the caller ID number matches a stored caller ID number associated with the personal medical information.

3. A method as defined in claim 1, further comprising determining an identity of a person associated with the call based on the caller ID number.

4. A method as defined in claim 1, wherein the personal medical information comprises information about at least one of an allergy, a past or current medical treatment, a doctor, or a hospital.

5. A method as defined in claim 1, wherein the personal medical information comprises emergency contact information.

6. A method as defined in claim 1, further comprising:
receiving an access code;
determining if the access code matches a stored access code, wherein providing access to the personal medical information is performed when the caller ID number matches the stored caller ID number associated with the personal medical information and the access code matches the stored access code.

7. A method as defined in claim 6, further comprising denying access to the personal medical information when the access code does not match the stored access code.

8. A method as defined in claim 6, wherein the access code is a medical personnel access code.

9. A method as defined in claim 1, wherein the caller ID number is an automatic number identification (ANI) system, a calling number identification (CNID) system, a calling line identification (CLI) system, a calling line identification presentation (CLIP) system, or a calling line identification (CLID) system.

10. A method as defined in claim 1, further comprising:
receiving a user identifier that is different from the caller ID number;
providing access to the personal medical information when the caller ID number matches a stored caller ID number associated with the personal medical information and when the user identifier is associated with a health care provider.

11. A method as defined in claim 10, further comprising receiving an access code, wherein providing access to the personal medical information is performed when the caller ID number matches a stored caller ID number, when the user identifier is associated with the health care provider, and the access code matches a stored access code associated with the user identifier.

12. A method as defined in claim 10, wherein the health care provider is an emergency services provider.

13. A method as defined in claim 1, wherein receiving the caller ID number comprises receiving a called telephone number.

14. A method as defined in claim 13, wherein the called telephone number is a three-digit access code.

15. A method as defined in claim 13, further comprising routing a call associated with the received called telephone number to an interactive voice response system based on the called telephone number, wherein the interactive voice response system is to provide the personal medical information when the received caller ID number matches the stored caller ID number.

16. A method as defined in claim 1, further comprising converting the personal medical information to spoken words.

17. A method as defined in claim 1, further comprising providing a webpage for modifying at least one of the stored caller ID number or the personal medical information.

18. A method as defined in claim 1, wherein receiving the caller ID number comprises receiving a call from at least one of a mobile phone, a voice over internet protocol phone, or a public switched telephone network phone.

19. An apparatus for providing access to personal medical information, the apparatus comprising:
a communication device to receive a call requesting personal medical information;
a caller ID receiver to determine a caller ID number associated with the call; and
an interactive voice response engine to provide personal medical information when the caller ID number matches a stored caller ID number associated with the personal medical information.

20. An apparatus as defined in claim 19, further comprising an authentication server to determine an identity of a person associated with the call based on the caller ID number.

21. An apparatus as defined in claim 19, wherein the personal medical information comprises at least one of a medicine identification, an allergy identification, a past medical treatment identification, a doctor identification, or a health care provider identification.

22. An apparatus as defined in claim 19, wherein the personal medical information comprises emergency contact information.

23. An apparatus as defined in claim 19, wherein the communication device is to receive an access code.

24. An apparatus as defined in claim 23, further comprising an authentication server to determine if the access code matches a stored access code, wherein providing access to the personal medical information is performed when the caller ID number matches the stored caller ID number and the access code matches the stored access code.

25. (canceled)

26. An apparatus as defined in claim 19, wherein the caller ID number is an automatic number identification (ANI) system, a calling number identification (CNID) system, a calling line identification (CLI) system, a calling line identification presentation (CLIP) system, or a calling line identification (CLID) system.

27. An apparatus as defined in claim 19, wherein the communication device is further to receive a user identifier that is different from the caller ID number and the interactive voice response engine is further to provide access to personal medical information when the caller ID number matches a stored caller ID number and when the user identifier is associated with at least one of a medical provider or an emergency services provider.

28. An apparatus as defined in claim 27, wherein the communication device is further to receive an access code, wherein providing access to personal medical information is performed when the caller ID number matches a stored caller ID number, when the user identifier is associated with at least one of a medical provider or an emergency services provider, and the access code matches a stored access code associated with the user identifier.

29. An apparatus as defined in claim 19, wherein receiving the caller ID number comprises receiving a called telephone number.

30. An apparatus as defined in claim 29, wherein the called telephone number is a three-digit access code.

31. An apparatus as defined in claim 29, wherein the communication device is further to route a call associated with the received called telephone number to an interactive voice response system based on the called telephone number, wherein the interactive voice response system is to provide the personal medical information when the received caller ID number matches the stored caller ID number.

32-33. (canceled)

34. An apparatus as defined in claim 19, wherein receiving a caller ID number comprises receiving a call from at least one of a mobile phone, a voice over internet protocol phone, or a public switched telephone network phone.

35. An article of manufacture storing machine readable instructions which, when executed, cause a machine to:
receive a caller ID number; and
provide access to personal medical information associated with the caller ID number when the caller ID number matches a stored caller ID number associated with the personal medical information.

36. An article of manufacture as defined in claim 35, wherein access to the personal medical information associated with the caller ID number is provided when the caller ID number matches a stored caller ID number associated with the personal medical information.

37. An article of manufacture as defined in claim 35, wherein the machine readable instructions further cause the machine to determine an identity of a person associated with the call based on the caller ID number.

38. An article of manufacture as defined in claim 35, wherein the personal medical information comprises information about at least one of an allergy, a past or current medical treatment, or a health care provider.

39. An article of manufacture as defined in claim 35, wherein the personal medical information comprises emergency contact information.

40-57. (canceled)
